(19) United States
(12) Patent Application Publication
(10) Pub. No.: US 2025/0374918 A1
(43) Pub. Date: Dec. 11, 2025

(54) SYSTEM FOR PERFUSION OF BIOLOGICAL SAMPLES

(71) Applicant: Paragonix Technologies, Inc., Waltham, MA (US)

(72) Inventors: Michael Tajima, Braintree, MA (US); William Lucas Churchill, Braintree, MA (US)

(21) Appl. No.: 19/229,803

(22) Filed: Jun. 5, 2025

Related U.S. Application Data
(60) Provisional application No. 63/657,717, filed on Jun. 7, 2024.

(51) Int. Cl. A01N 1/162; A01N 1/126; A01N 1/143

(52) U.S. Cl. CPC A01N 1/162; A01N 1/126; A01N 1/143

(57) ABSTRACT

A normothermic perfusion circuit can be used to perfuse a donor heart after transportation and before transplantation. The circuit can drain the organ storage container of cold preservation solution, perfuse the aorta of the heart with warm fluid to initiate heart activity, and then perfuse the left atrium of the heart with warm fluid to bolster heart activity and evaluate heart viability. Heart viability can be determined using parameters measured by sensors in the circuit.

### INCORPORATION BY REFERENCE TO ANY PRIORITY APPLICATIONS

Any and all applications for which a foreign or domestic priority claim is identified in the Application Data Sheet as filed with the present application are hereby incorporated in their entireties by reference under 37 CFR 1.57. In particular, this application claims priority to the U.S. Provisional Application 63/657,717, filed Jun. 7, 2024, which is incorporated by reference herein in its entirety.

### FIELD

This disclosure relates to systems and method for normothermic machine perfusion and viability testing of biological samples, for example tissues for donation. The systems and methods provide a secure, sterile, and temperature-controlled environment for perfusing and testing viability of the samples.

### BACKGROUND

There is a critical shortage of donor organs. Hundreds of lives could be saved each day if more organs (heart, kidney, lung, etc.) were available for transplant. While the shortage is partly due to a lack of donors, there is a need for better methods of preserving, transporting, and evaluating viability of donated organs. Current normothermic perfusion and evaluation methods are expensive, resource intensive, and limited. Normothermic perfusion after transportation can benefit results of the transplantation of donor organs. Current evaluation technologies provide a crude viability assessment, for example using lactate clearance for all organs or Langendorff perfusion for hearts.

Improved normothermic perfusion and viability testing for organs would increase the pool of available organs while improving outcomes for recipients.

### SUMMARY

The disclosure provides an improved system and method for normothermic perfusion and testing viability of biological samples, e.g., tissues, such as donor organs, for transplantation. In certain examples, this improved system and method may greatly improve the feasibility and benefit of organ transplantation and, consequently, make many more organs available for donation. Additionally, the samples may be healthier upon arrival, as compared to state-of-the-art perfusion methods. In some examples, organ perfusion can prolong viability of donor organs, for example hearts, by ensuring uniform temperature and flushing out of metabolites. Current organ perfusion devices are often limited by being designed for transport and lacking effective evaluation systems.

Examples of the disclosed systems and methods overcome the shortcomings of the prior art by providing a normothermic perfusion circuit that can connect with an organ storage container, utilize extracorporeal membrane oxygenation (ECMO) or cardiopulmonary bypass (CPB) systems, efficiently resuscitate a heart, and provide a means for effective evaluation of organ viability. For example, the normothermic perfusion circuit described herein can include reservoirs disposed at different heights, a pump, a canister having a perfusion port, a canister having a drain, and/or an oxygenator configured to gradually perfuse a heart with warm, oxygenated fluid after hypothermic transportation.

In some examples, the systems described herein can include: a canister configured to contain a donor heart, the canister including: a drain configured to drain preservation fluid from the canister; and a perfusion port configured to connect with an aorta of the donor heart; and a reservoir containing fluid at a normothermic temperature, wherein the donor heart is configured to be perfused with the fluid without opening the canister.

In some examples, the methods described herein can include: preserving a donor organ in an organ container containing preservation solution having a temperature of between 2° C. and 10° C., wherein the organ container is coupled with a lid to form an insulated environment in an interior of the organ container; draining, through a drain of the organ container, at least some preservation solution from the interior of the organ container to an exterior of the organ container without removing the lid from the organ container; perfusing, via a perfusion port of the organ container or the lid, a vessel of the donor organ with fluid having a temperature of between 20° C. and 40° C. without removing the lid from the organ container.

In some examples, perfusing the vessel of the donor organ includes pumping, with a pump, the fluid through the perfusion port. In some examples, the perfusion port is in fluid communication with an adapter, the adapter in fluid communication with the vessel of the donor organ. In some examples, the adapter includes a cannula coupled with the organ container. In some examples, draining the at least some preservation solution from the interior of the organ container includes releasing the fluid from the drain on a bottom surface of the organ container. In some examples, the fluid includes blood. In some examples, the methods described herein can include disconnecting the perfusion port from a hypothermic perfusion circuit before perfusing the vessel of the donor organ with the fluid. In some examples, the donor organ is a heart and the vessel of the donor organ is an aorta.

In some examples, the systems described herein can include: an organ container configured to contain a donor organ, the organ container including: an adapter configured to fluidically couple with a vessel of the donor organ; a perfusion port in fluid communication with the adapter; and a drain configured to allow fluid in the organ container to flow out of the organ container; and a reservoir containing fluid at a normothermic temperature; and a tube configured to fluidically couple the reservoir with the perfusion port such that the reservoir is in fluid communication with the vessel of the organ without opening the organ container.

In some examples, the adapter is a cannula coupled with a cannula receiver of the organ container. In some examples, at least one of the perfusion port or the adapter is on a lid of the organ container. In some examples, the drain is on a bottom surface of the organ container. In some examples, at least one of the perfusion port or the adapter is disposed above the drain. In some examples, the fluid contained in the reservoir is blood. In some examples, the perfusion port is configured to be closed during transportation. In some examples, the perfusion port is configured to be coupled with a hypothermic perfusion circuit during transportation. In some examples, the systems described herein can include an organ rest configured to support the organ, the organ rest including an opening configured to allow fluid to flow between the perfusion port and the drain. In some examples, the organ container contains preservation solution at a temperature between 2° C. and 10° C. In some examples, the reservoir contains fluid at a temperature between 20° C. and 40° C. In some examples, the organ is a heart and the adapter is configured to couple with an aorta.

In some examples, the methods described herein can include: opening a drain of a canister containing a donor organ such that preservation solution flows out of the canister; connecting a tube to a perfusion port of the canister, the tube in fluid communication with a reservoir containing fluid at a normothermic temperature, such that the fluid in the reservoir flows through the perfusion port to an adapter, the adapter in fluid communication with a vessel of the donor organ; and perfusing the donor organ with the fluid at a normothermic temperature without removing a lid from the canister.

In some examples, the methods described herein can include pumping, with a pump, the fluid from the reservoir to the perfusion port. In some examples, the methods described herein can include disconnecting a hypothermic perfusion circuit from the perfusion port of the canister. In some examples, the preservation solution is at a temperature of between 2° C. and 8° C. In some examples, the reservoir contains fluid at a temperature between 20° C. and 40° C.

In some examples, the systems described herein can include: a canister configured to contain a donor heart; a first reservoir; a first tube having a proximal end and a distal end, the proximal end in fluid communication with the first reservoir and the distal end configured to fluidically communicate with an aorta of the donor heart; a second reservoir; a second tube having a proximal end and a distal end, the proximal end in fluid communication with the second reservoir and the distal end configured to fluidically communicate with a left atrium of the donor heart; a third reservoir in fluid communication with the first reservoir and the second reservoir by a plurality of tubes; and a pump configured to pump fluid from the third reservoir to at least one of the first reservoir or the second reservoir.

In some examples, the canister includes a drain configured to drain fluid from the canister to the third reservoir. In some examples, the systems described herein can include valves configured to selectively allow fluid to flow from the third reservoir to the first reservoir or the second reservoir. In some examples, the systems described herein can include an oxygenator configured to oxygenate fluid pumped from the third reservoir. In some examples, the first reservoir and the second reservoir are configured to release excess fluid to the third reservoir through the plurality of tubes. In some examples, the second reservoir is configured to receive fluid from the left atrium of the donor heart via the second tube. In some examples, the first reservoir and the second reservoir are positioned above the canister. In some examples, the canister includes one or more ports configured to allow a user to take a sample of the fluid. In some examples, the fluid is blood. In some examples, the distal end of the first tube is connected to the aorta. In some examples, the distal end of the second tube is connected to a pulmonary vein.

In some examples, the methods described herein can include: providing a first reservoir, a second reservoir, and a third reservoir, the third reservoir in fluid communication with the first reservoir and the second reservoir via a plurality of tubes; pumping fluid from the third reservoir to the first reservoir, the first reservoir in fluid communication with an aorta of a donor heart via a first tube; measuring, with one or more sensors, one or more parameters of the donor heart; determining, based on the one or more parameters of the donor heart, whether the heart is active or inactive; and when the heart is active, pumping fluid from the third reservoir to a second reservoir via the plurality of tubes, the second reservoir in fluid communication with a left atrium of the donor heart via a second tube and ceasing pumping fluid from the third reservoir to the first reservoir via the plurality of tubes.

In some examples, the one or more sensors includes an electrocardiogram and the one or more parameters of the donor heart includes electrical activity. In some examples, the one or more sensors includes a pressure sensor and the one or more parameters of the donor heart includes at least one of left atrial pressure, aortic pressure, or left ventricular pressure. In some examples, the one or more sensors includes a pressure sensor and the one or more parameters of the donor heart includes at least one of left atrial pressure, aortic pressure, and/or left ventricular pressure. In some examples, the one or more sensors includes a temperature sensor and the one or more parameters of the donor heart includes temperature. In some examples, the one or more sensors includes a flow sensor and the one or more parameters of the donor heart includes flow velocity of the fluid. In some examples, the methods described herein can include displaying a weight of at least one of the first reservoir or the second reservoir on a display. In some examples, the methods described herein can include connecting a distal end of the first tube to the aorta. In some examples, the methods described herein can include connecting a distal end of the second tube to a pulmonary vein.

In some examples, the methods described herein can include: storing a donor heart in a canister filled with cold preservation solution; draining the cold preservation solution from the canister; and perfusing the donor heart with warm fluid through a port in the canister. In some examples, the warm fluid is blood.

In some examples, the systems described herein can include: a canister configured to contain a donor heart, the canister configured to be filled with preservation fluid; a drain disposed at a bottom of the canister, the drain configured to drain the preservation fluid from the canister; and an organ rest positioned above the bottom of the canister, the organ rest configured to support the donor heart as the preservation fluid is drained from the canister. In some examples, the organ rest includes apertures configured to allow preservation fluid above the organ rest to flow to the drain.

In some aspects, the techniques described herein relate to a method for assessing viability of a donor heart, the method including: pumping fluid to a left atrium of a donor heart; measuring, with one or more sensors, one or more parameters of the donor heart; determining, based on the one or more parameters of the donor heart, a left ventricular pressure and a left ventricular volume of the donor heart; determining, based on the left ventricular pressure and the left ventricular volume of the donor heart, an indicator including at least one of: an unstressed left ventricular volume of the donor heart; a ventricular contractility of the donor heart; an end-systolic PV relationship of the donor heart; or an end-diastolic PV relationship of the donor heart; and determining, based on the indicator, whether the donor heart is viable for transplantation.

In some examples, the methods described herein can assess viability of a donor heart, the method including: pumping fluid to a left atrium of a donor heart; measuring, with a first pressure sensor, a left atrial pressure of the donor heart; measuring, with a second pressure sensor, an aortic pressure of the donor heart; determining, based on the left atrial pressure and the aortic pressure, a ventricular pressure of the donor heart; and determining, based on the ventricular pressure, whether the donor heart is viable for transplantation.

In some examples, the systems described herein can include: a canister configured to contain a donor heart, the canister including a port, wherein the port is configured to fluidically communicate with the donor heart when the donor heart is contained in the canister; a reservoir containing fluid at a normothermic temperature; a tube configured to couple the reservoir to the port; and a pump configured to perfuse the donor heart with the fluid from the reservoir when the donor heart is contained in the canister and the tube couples the reservoir to the port.

In some examples, the methods described herein can include: preserving a donor organ in a canister containing a first fluid, wherein the canister is coupled with a lid; draining, through a drain of the canister, at least some of the first fluid or a second fluid from an interior of the canister to an exterior of the canister without removing the lid from the canister; perfusing, via a perfusion port of the canister or the lid, a vessel of the donor organ with a second fluid without removing the lid from the canister.

In some examples, the first fluid includes preservation solution at a temperature between 2° C. and 10° C. In some examples, the second fluid includes preservation solution at a temperature between 20° C. and 40° C. In some examples, the second fluid includes blood at a temperature between 20° C. and 40° C. In some examples, the first fluid includes blood preservation solution at a temperature between 20° C. and 40° C. In some examples, perfusing the vessel of the donor organ includes pumping, with a pump, the second fluid through the perfusion port. In some examples, the perfusion port is in fluid communication with an adapter, the adapter in fluid communication with the vessel of the donor organ. In some examples, the adapter includes a cannula coupled with the canister. In some examples, draining the at least some first fluid from the interior of the canister includes releasing the first fluid from the drain on a bottom surface of the canister. In some examples, the methods described herein can include disconnecting the perfusion port from a hypothermic perfusion circuit before perfusing the vessel of the donor organ with the second fluid. In some examples, the donor organ is a heart and the vessel of the donor organ is an aorta.

In some examples, the methods described herein can include: preserving a donor organ in an organ container containing preservation solution having a temperature of between 2° C. and 10° C., wherein the organ container is configured to be closed; draining, through a drain of the organ container, at least some preservation solution from an interior of the organ container to an exterior of the organ container while the organ container is closed; and perfusing, via a perfusion port of the organ container or the lid, a vessel of the donor organ with fluid having a temperature of between 20° C. and 40° C. while the organ container is closed.

### BRIEF DESCRIPTION OF THE DRAWINGS

FIG. 1 is a schematic illustration of an example of a normothermic perfusion circuit.

FIG. 2 shows an example of a canister with an organ rest and a drain.

FIG. 3 shows an example of a normothermic perfusion circuit suspended from a suspension component.

FIG. 4 shows an example of a graph of left atrial pressure and aortic pressure used to estimate ventricular pressure.

### DETAILED DESCRIPTION

The disclosed systems and methods for normothermic perfusion provide for evaluation of the viability of an organ and preparing the organ for transplantation. The normothermic perfusion circuit can be connected to an organ storage container or canister containing an organ. The circuit can be incorporated with extracorporeal membrane oxygenation (ECMO) or cardiopulmonary bypass (CPB) systems. The circuit can include sensors for measuring parameters to determine viability of the organ for transplantation.

Current ex-vivo heart perfusion devices often perfuse the heart in an unloaded manner or a loaded manner. Perfusing the heart in an unloaded manner includes perfusing via the aorta, in which the heart returns to a beating state, but the left ventricle remains unloaded. Perfusing the heart in a loaded manner includes perfusing via the left atrium, in which the left ventricle is loaded. The disclosed systems and methods for normothermic perfusion in clinical use can include perfusing the heart in an unloaded manner to initiate heart activity and then perfusing in a loaded manner to resuscitate the heart and/or evaluate the heart's viability. The disclosed apparatuses systems and methods allow a circuit for unloaded and loaded perfusion to be integrated with an organ container and independent pumps. Advantageously, this can allow the organ container to transition from hypothermic storage to normothermic perfusion. Additionally, the systems and methods described herein can provide feedback to the user with instructions on controlling the pump connected to the circuit.

As used in this specification, the singular forms “a,” “an” and “the” include plural referents unless the context clearly dictates otherwise. Thus, for example, the term “a fluid” is intended to mean a single fluid or a combination of fluids.

As used herein, “a fluid” refers to a gas, a liquid, or a combination thereof, unless the context clearly dictates otherwise. For example, a fluid can include oxygen, carbon dioxide, or another gas. In another example, a fluid can include a liquid. Specifically, the fluid can be a liquid perfusate. In still another example, the fluid can include a liquid perfusate with a gas, such as oxygen, mixed therein or otherwise diffused therethrough.

As used herein, “tissue” refers to any tissue of a body of a patient, including tissue that is suitable for being replanted or suspected of being suitable for replantation. Tissue can include, for example, muscle tissue, such as, for example, skeletal muscle, smooth muscle, or cardiac muscle. Specifically, tissue can include a group of tissues forming an organ, such as, for example, the lungs, heart, liver, kidney, pancreas, or other organ. In another example, tissue can include nervous tissue, such as a nerve, the spinal cord, or another component of the peripheral or central nervous system. In still another example, tissue can include a group of tissues forming a bodily appendage, such as an arm, a leg, a hand, a finger, a thumb, a foot, a toe, an ear, genitalia, or another bodily appendage. While the systems are described as relating to the transport of tissues, such as organs, it is also envisioned that the systems could be used for the transport of body fluids, which may be held in another container within the self-purging preservation apparatus. Body fluids may include blood and blood products (whole blood, platelets, red blood cells, etc.) as well as other body fluids for preservation.

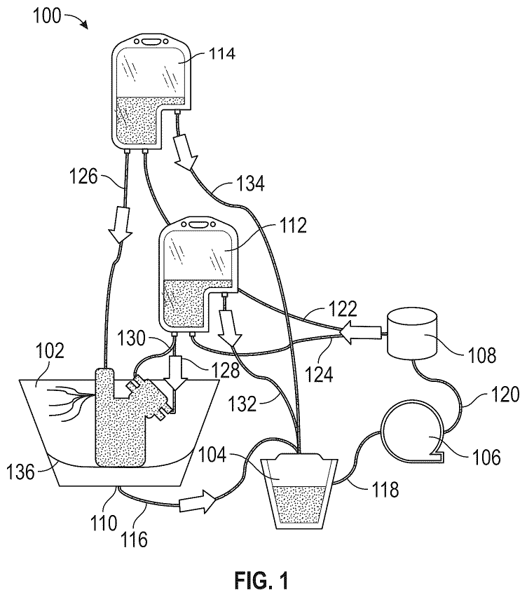

FIG. 1 is a schematic illustration of an example of a normothermic perfusion circuit 100.

In a non-limiting example, the normothermic perfusion circuit 100 can be used for perfusing a heart ex-vivo after hypothermic transportation of the heart. The normothermic perfusion circuit 100 can be used to resuscitate the heart and/or evaluate the viability of the heart for transplantation. In some examples, the circuit 100 can drain the organ storage container 102 of cold preservation solution, perfuse the aorta of the heart with warm fluid to initiate heart activity, and then perfuse the left atrium of the heart with warm fluid to bolster heart activity and/or evaluate heart viability. In certain examples, the normothermic perfusion circuit 100 can include three reservoirs for holding fluid, a pump 106, an oxygenator 108, and a series of tubes in connection with an organ storage container 102.

In some examples, the heart can be transported ex-vivo at hypothermic temperatures to reach a location of a patient receiving the organ. Once the heart reaches the target location, the circuit 100 can be used to drain the organ storage container 102 of cold preservation solution. Then, the circuit 100 can begin to slowly perfuse the heart with warm fluid, such as blood, to warm up and resuscitate the heart. In some examples, with warm fluid can be normothermic perfusion, or perfusion at a temperature of between 36° C. and 38° C. In some examples, the organ can be perfused at a normothermic temperature of between 30° C. and 40° C. In some examples, the organ can be perfused at a normothermic or sub-normothermic temperature of between 21° C. and 36° C. In some examples, the organ can be perfused at a normothermic or sub-normothermic temperature of between 20° C. and 40° C. In some examples, the organ can be perfused at a normothermic or sub-normothermic temperature of between 12° C. and 37° C.

In certain examples, initial perfusion of the heart can be unloaded perfusion, or perfusion through the aorta. One or more sensors can be used to measure one or more parameters of the heart. In some examples, a processor can receive the measurements from the sensors and determine whether the heart is active or inactive. In some examples, a user can receive the measurements from the sensors and determine whether the heart is active or inactive. In examples, the sensor can be an electrocardiogram electrode, a pressure sensor, a temperature sensor, and/or a flow sensor. A heart can be considered active based on electrical activity, pressure in a left ventricle, left atrium, and/or aorta, a temperature, and/or a flow velocity of fluid through the heart. Once the organ begins to function, the direction of flow can be reversed to perfuse the left atrium for a loaded assessment.

In some examples, the circuit 100 can include sensors that measure cardiac output and/or cardiac power. Pressure sensors can be used to measure arterial pressure. Volume sensors or flow sensors can be used to measure fluid entering and exiting the heart. Pressure sensors or flow sensors can measure the outputs and inputs of each element of the circuit 100, for example the organ storage container and/or each reservoir. In some examples, left ventricular pressure can be measured using sensors in the circuit 100 or calculated through extrapolation of the measurements. In some examples, left ventricular volume can be measured using sensors in the circuit 100 or calculated through extrapolation of the measurements. In examples, pressure-volume loops can be measured over time to establish viability of heart function.

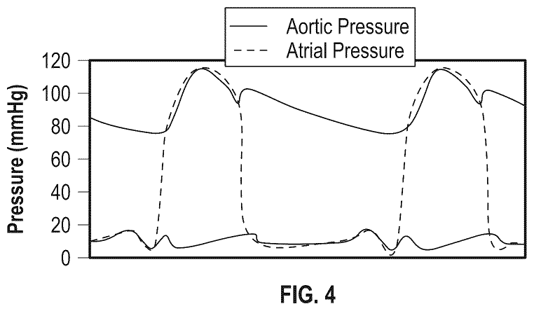

In some examples, the sensors in the circuit 100 can measure the aortic pressure and the atrial pressure. Based on the aortic pressure and the atrial pressure, a processor or user can estimate or determine ventricular pressure as described with respect to FIG. 4.

In some examples, an input flow sensor and an output flow sensor can be used to measure input flow to the heart and output flow from the heart. Based on the input flow and the output flow of the heart, a processor or a user can calculate cardiac output and pressure-volume flow loops.

In examples, the circuit 100 can include an organ storage container 102. The organ storage container 102 can contain a biological sample, for example a heart. In some examples, the organ storage container 102 can contain a lung, a kidney, a pancreas, or a liver. The organ storage container 102 can be a canister for storing an organ. In some examples, the organ storage container 102 can be used for hypothermic transport of the organ before being connected to the rest of the circuit 100.

In some examples, the organ storage container 102 can include a drain 110. In some examples, the drain 110 can be disposed at the bottom of the organ storage container 102. The drain 110 can connect to a reservoir 104 using a drain tube 116. Once the organ storage container 102 is connected to the circuit 100, the cold preservation solution in the organ storage container 102 can be drained through the drain 110. The cold preservation solution can travel through the drain 110 to the drain tube 116 into the reservoir 104.

In some examples, the organ storage container 102 can include an organ rest 136 to support the organ when fluid is drained. Advantageously, this can prevent strain on the organ as preservation fluid is drained from the organ storage container 102. The organ rest 136 can be a support structure configured to support the organ from beneath the organ. In some examples, the organ is also suspended from an adapter. In some examples, the organ is cannulated and entirely supported by the organ rest 136. In some examples, the organ rest 136 can include holes or apertures that allow preservation solution to drain from the space above the organ rest 136 in the canister.

In certain examples, the heart can be cannulated in the left atrium and/or the aorta. In some examples, the heart can be cannulated before hypothermic transport. In this example, the heart can be connected to the circuit 100 after hypothermic transport without opening the organ storage container 102. In some examples, the organ storage container 102 can include perfusion ports. The perfusion ports can be connected directly to the left atrium and/or the aorta via the cannulas. In some examples, the organ storage container 102 can be opened after hypothermic transportation and the heart can be cannulated before normothermic perfusion.

One or more of the tubes 126, 128, 130 can be connected to the organ storage container 102 via the perfusion ports so they are in fluid communication with the aorta, the left atrium, an artery, and/or a vein. In some examples, the coronaries can intake fluid from the organ storage container 102 into the donor heart. In some examples, the fluid taken in from the coronaries can exit the heart from the coronary sinus and flow into the organ storage container 102. In some examples, the fluid returning to the canister from the coronary sinus can drain out of the canister through the drain 110.

In an example, the preservation fluid can collect in the organ storage container 102 without being drained. In this example, the preservation solution can support the heart, provide thermal control, and/or enable certain measures such as echo without direct contact with the heart.

The circuit 100 can include a pump setup, for example a cardiopulmonary bypass or extracorporeal membrane oxygenation machine. The pump setup can include a reservoir 104, a pump 106, and/or an oxygenator 108.

In examples, the circuit 100 can include an aortic reservoir 114 and/or a left atrium reservoir 112. Each reservoir 112, 114 can be a compliant bag that is able to be filled with fluid. Each reservoir 112, 114 can be a bag made of a flexible material. Each reservoir 112, 114 can be a hanging bag, for example a bag that hangs on a frame. The pump 106 can fill each reservoir 112, 114 and each reservoir 112, 114 can allow fluid to flow to the organ. Advantageously, using the reservoirs 112, 114 can decouple the flow of fluid between the pump 106 and the organ. If the pump 106 were to pump fluid directly to the heart without the reservoirs 112, 114, and the heart were to eject against the flow of fluid, it could cause hemolysis. Therefore, the rate of the pump would have to be integrated with the rate of the beating heart. Advantageously, with the reservoirs 112, 114 to decouple the pump 106 from the heart, the pump 106 can operate independently of the rate of the beating heart. The pump 106 can ensure that at least one of the aortic reservoir 114 or the left atrium reservoir 112 has enough fluid to provide a head pressure to the respective vessel. Any excess fluid can drain back into the reservoir 104. If the heart ejects, there can be little or no backflow against the pump due to the compliance of the reservoirs 112, 114.

In certain examples, once heart activity begins during perfusion, the flow rate demand of the heart can be pulsatile based on the heart rate. However, the pump 106 can provide a continuous flow to the reservoirs 112, 114. The heart can intake fluid from the reservoirs 112, 114 in a pulsatile manner. Each reservoir 112, 114 can have capacity to intake blood from the heart based on a heart ejection. For example, when the heart goes into diastole, fluid from the left atrium reservoir 112 can enter the heart through the tube 128. In some examples, the tube 128 can be connected to a pulmonary vein, for example a left and/or right pulmonary vein. In some examples, when the heart goes into systole, fluid can flow from the aorta of the heart to the aortic reservoir 114 through the tube 126.

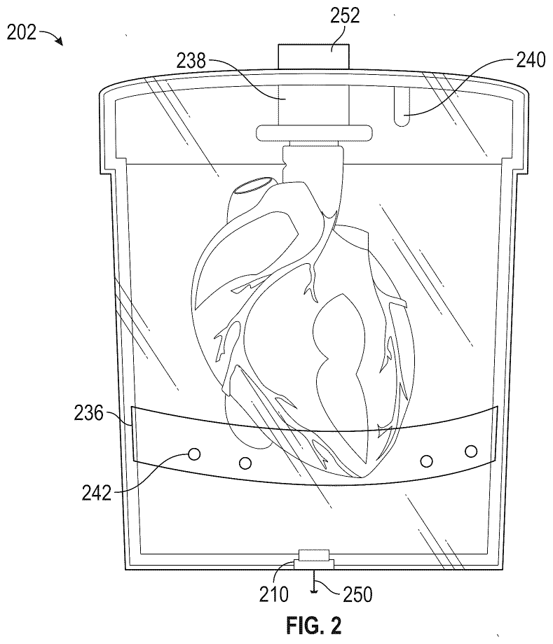

In examples, the circuit 100 can include an aortic reservoir 114. The aortic reservoir 114 can set the head pressure for the aorta. For example, the aortic reservoir 114 can be positioned at a height set to create aortic pressure. In some examples, the aortic reservoir 114 can use a pneumatic pressure cuff to control the aortic pressure. The aortic reservoir 114 can be connected to the aorta by a perfusion tube 126. Fluid, for example blood, can flow from the aortic reservoir 114 through the perfusion tube 126 to the aorta. In some examples, the fluid can be preservation solution. The aortic reservoir 114 can be compliant to allow for ejection volume of blood from left ventricular systolic ejection. Excess fluid can be released from the aortic reservoir 114 to the reservoir 104 via the tube 134. Initially, the aortic reservoir 114 can feed fluid to the coronaries of the heart via the perfusion tube 126 and the aorta. In some examples, after the heart begins pumping, flow from the aortic reservoir 114 to the aorta via the tube 134 may be stopped as forward flow of the heart feeds fluid into the tube 134 in the opposite direction. In some examples, the one or more of the perfusion tubes 126, 128, 130 can connect to one or more of the superior vena cava, inferior vena cava, anterior cardiac veins, smallest cardiac veins, or coronary sinus. In some examples, the one or more of the perfusion tubes 126, 128, 130 can connect to a perfusion port as described with respect to FIG. 2.

In some examples, the target aortic pressure in the circuit 100 can be 50-60 mmHg. In some examples, the aortic reservoir 114 can be positioned at a height of 70-80 cm above the aorta of the donor heart to create the target pressure in the aorta. In some examples, the aortic reservoir 114 can be positioned at a height of 60-90 cm above the aorta of the donor heart to create the target pressure in the aorta. In some examples, the aortic reservoir 114 can be positioned at a height of 50-100 cm above the aorta of the donor heart to create the target pressure in the aorta.

In some examples, the pump 106 can be an electric pump, a roller pump, a peristaltic pump, and/or a centrifugal pump. The pump 106 can pump fluid such that the tube 118 intakes fluid from the reservoir 104. The pump 106 can pump fluid from the tube 118 to the oxygenator 108 via the tube 120. The oxygenator 108 can oxygenate the fluid passing from the tube 120. Fluid can flow from the oxygenator 108 to the aortic reservoir 114 via the tube 122 and/or to the left atrium reservoir 112 via the tube 124. Thus, the aortic reservoir 114 and/or the left atrium reservoir 112 can be constantly filled with oxygenated fluid during operation of the circuit 100. The circuit 100 can be modular such that existing elements can be incorporated in the circuit 100. For example, hemoconcentrators, cell savers, heaters, coolers, and/or other tools for organ management can be incorporated in the circuit 100.

In examples, the circuit 100 can include a left atrium reservoir 112. The left atrium reservoir 112 can set the head pressure for the left atrium. For example, the left atrium reservoir 112 can be positioned at a height set to create left atrial pressure. In some examples, the left atrium reservoir 112 can be positioned at a lower height than the aortic reservoir 114, such that the head pressure for the aorta is lower than the head pressure for the left atrium. In some examples, the left atrium reservoir 112 can use a pneumatic pressure cuff to control the left atrial pressure. The left atrium reservoir 112 can be connected to the left atrium by a perfusion tube 128. Fluid, for example blood, can flow from the left atrium reservoir 112 through the perfusion tube 128 to the left atrium. In some examples, the fluid can be preservation solution.

In certain examples, the left atrium reservoir 112 can also be connected to the left atrium by a tube 130. In some examples, the tube 130 can be connected to a pulmonary vein, for example a left and/or right pulmonary vein. The tube 130 can allow fluid to flow from the left atrium to the left atrium reservoir 112 without interrupting the flow of fluid through the perfusion tube 128 in the opposite direction. Excess fluid can be released from the left atrium reservoir 112 to the reservoir 104 via the tube 132. Initially, when the heart is cold, the left atrium reservoir 112 can be closed off. For example, initially, the tube 124 bringing oxygenated fluid to the left atrium can be blocked. Once the heart warms, the coronaries can feed pumping activity, flow from the left atrium reservoir 112 to the left atrium can be opened to provide antegrade flow through the heart.

In some examples, the target left atrial pressure in the circuit 100 can be 5-15 mmHg. In some examples, the left atrium reservoir 112 can be positioned at a height of 7-21 cm above the left atrium of the donor heart to create the target pressure in the left atrium. In some examples, the left atrium reservoir 112 can be positioned at a height of 5-25 cm above the left atrium of the donor heart to create the target pressure in the left atrium. In some examples, the left atrium reservoir 112 can be positioned at a height of 1-30 cm above the left atrium of the donor heart to create the target pressure in the left atrium.

In certain examples, the circuit 100 can switch from unloaded perfusion of the heart through the aorta to loaded perfusion of the heart through the left atrium once the donor heart is active. In some examples, the donor heart can be deemed active when it is beating. In some examples, the circuit 100 can switch between unloaded perfusion of the heart through the aorta and loaded perfusion of the heart through the left atrium by pumping fluid through one of the tubes 122, 124 and ceasing flow through the other of the tubes 122, 124. During unloaded perfusion, fluid can flow from the oxygenator to the aortic reservoir 114. This can cause the circuit 100 to engage in perfusion of the heart through the aorta. During loaded perfusion, fluid can flow from the oxygenator to the left atrium reservoir 112. This can cause the circuit 100 to engage in perfusion of the heart through the left atrium. In some examples, a user can switch the circuit 100 between unloaded perfusion and loaded perfusion using a manual valve. In some examples, the tubes 122, 124 can include valves to selectively allow the flow of fluid to each reservoir 112, 114. In some examples, a processor can automatically switch the circuit 100 from unloaded perfusion to loaded perfusion when the heart starts beating.

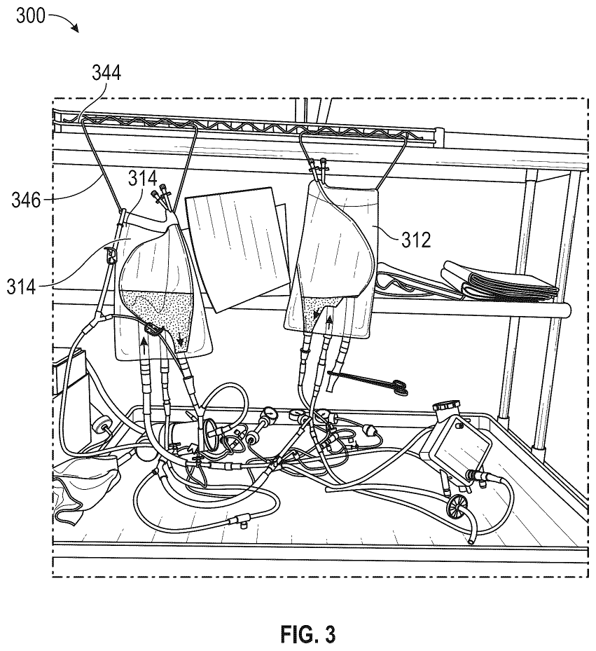

In certain examples, the circuit 100 can be mounted on a frame, such that elements of the circuit 100 are hanging. For example, the aortic reservoir 114 and/or the left atrium reservoir 112 can be hanging at a height configured to provide a suitable head pressure. The reservoir 104 can be positioned at a height below the organ storage container 102 such that fluid drains from the organ storage container 102 to the reservoir 104. In some examples, the reservoirs 112, 114 may be suspended from a suspension component as described with respect to FIG. 3. In some examples, the frame may be a smart frame. For example, the frame may include a visual indicator or display as described herein. In some examples, the frame may include one or more user input receivers, for example to allow a user to control the speed of the pump 106, change the direction of the pump 106, or change the direction of fluid flow from the pump 106. In some implementations, the frame may indicate to the user whether the organ storage container 102, ECMO machine, CPB machine, and/or reservoirs 112, 114 are properly connected.

In some examples, the pump 106 can include an automated feedback system. For example, the weight of the aortic reservoir 114 and/or the left atrium reservoir 112 can be measured to indicate the volume of the fluid in the reservoir. The flow of the pump 106 can be increased or decreased to match demand.

In some examples, the system can include a visual indicator or display. In some examples, the visual indicator or display can be on the organ storage container 102, a frame, or a user device. In some examples, the visual indicator can indicate the flow of the pump 106 to a user. In some examples, the visual indicator can indicate whether the heart is active or inactive. In some examples, the visual indicator can indicate measurements from the sensors in the circuit 100. In some examples, the visual indicator can indicate parameters of the organ derived from measurements from the sensors in the circuit 100. In some examples, the user can change the speed of the pump 106 while the organ is being perfused. In some examples, the user can change the direction of the pump 106 while the organ is being perfused. In some examples, the user can change the direction fluid flow from the pump 106 while the organ is being perfused. In some examples, the visual indicator may indicate the weight of at least one reservoir 104, 112, 114.

In some examples, the organ storage container 102 can include one or more ports for taking blood samples. Blood samples taken from a port of the canister can be used to measure gas concentrations, for example partial oxygen pressure, partial carbon dioxide concentration, oxygen saturation, and/or bicarbonate concentration. Blood samples taken from a port of the canister can be used to measure lactate concentration, electrolytes, metabolites, and/or enzymes. In some examples, the organ storage container 102 can include one or more ports for delivering therapeutics to the organ. For example, the organ storage container 102 can include ports for delivering vasodilators, vasoconstrictors, lytics, and/or other therapeutics to the organ.

In examples, pressure-volume loops of a donor heart undergoing perfusion can be used to assess whether the heart is viable for transplantation.

In certain examples, the ventricular pressure-volume (PV) relation can provide a complete characterization of cardiac pump performance. A PV diagram, or PV loop, can be created combining the simultaneous measurements of the intraventricular pressure and volume obtained during one or several comparable cardiac beats. A line connecting the end-systolic PV points or points at maximum elastance represents the end-systolic PV relationship (ESPVR). The slope is named the maximal ventricular elastance, or Ees. The ESPVR also has an intercept with the volume axis called Vo, which represents the hypothetical unstressed volume of the ventricle. Ees defines the contractile state of the ventricle, and it is relatively insensitive to loading conditions. Therefore, when ventricular contractility changes, Ees changes proportionally. A line depicting the exponential curve fit that connects the end-diastolic pressure-volume points also depicts the end-diastolic PV relationship (EDPVR), which characterizes the passive viscoelastic properties of the ventricle in diastole.

In some examples, the systems and methods described herein can use the Vo, ESPVR, Ees, and/or EDPVR to determine the viability of the heart for transplantation. For example, a heart can be connected to the circuit 100, and pressure-volume loops can be calculated using measurements from sensors in the system. One or more of Vo, ESPVR, Ees, or EDPVR can be used to determine ventricular compliance, diastolic function, cardiac reserve, structural integrity, systolic function, cardiac function of the donor heart, and/or viability of the heart for transplantation.

FIG. 2 shows an example of a canister 202 with an organ rest 236 and a drain 210.

The canister 202 can include one or more organ adapters 238 configured to cannulate a vessel of an organ. For example, the one or more organ adapters 238 can cannulate an aorta and/or a pulmonary vein of a left atrium of the heart. The canister 202 can include a temperature sensor 240.

In some examples, the canister 202 can include a drain 210. In some examples, the drain 210 can be disposed at the bottom of the canister 202. The drain 210 can connect to a reservoir using a drain tube. Once the canister 202 is connected to a circuit, the cold preservation solution in the canister 202 can be drained through the drain 210. The cold preservation solution can travel through the drain 210 to the drain tube into the reservoir.

In some implementations, the drain 210 can include a barb 250. The barb 250 may allow the drain 210 to connect to a drain tube. The drain tube may have an end configured to couple with the barb 250 fitting. The drain 210 may be closed during hypothermic transport of the organ in the canister 202. The drain 210 may be opened when coupled with the drain tube. A valve may be incorporated in the drain 210. For example, the drain 210 may include a shut-off valve configured to allow a user to open and close flow through the drain 210. In some examples, the drain 210 may include a directional valve configured to allow a user to switch the direction of flow allowed through the drain 210.

In some examples, the canister 202 can include an organ rest 236 to support the organ when fluid is drained. Advantageously, this can prevent strain on the organ as preservation fluid is drained from the canister 202. The organ rest 236 can be a support structure configured to support the organ from beneath the organ. In some examples, the organ is also suspended from the organ adapter 238. In some examples, the organ is entirely supported by the organ rest 136. In some examples, the organ rest 236 can include holes 242, or apertures, that allow preservation solution to drain from the space above the organ rest 236 in the canister 202.

In some examples, the organ adapter 238 can be fluidically coupled with a perfusion port 252. In other examples, the canister 202 and/or lid can lack a perfusion port 252. The perfusion port 252 can be configured to fluidically couple with a normothermic perfusion circuit, for example as described with respect to FIGS. 1 and 3. The perfusion port 252 can receive fluid at a normothermic temperature. In some examples, perfusion with warm fluid can be normothermic perfusion, or perfusion at a temperature of between 36° C. and 38° C. In some examples, the organ can be perfused at a normothermic temperature of between 30° C. and 40° C. In some examples, the organ can be perfused at a normothermic temperature of between 20° C. and 40° C. In some examples, the organ can be perfused at a normothermic or sub-normothermic temperature of between 21° C. and 36° C. In some examples, the organ can be perfused at a normothermic or sub-normothermic temperature of between 12° C. and 37° C. In some examples, the fluid at a normothermic temperature can be blood. In some examples, the fluid at a normothermic temperature can be preservation fluid. In some examples, the fluid at a normothermic temperature can be cellular solution.

In some examples, the canister 202 can be an organ container. In some examples, the canister 202, or organ container, can be a bag or a plurality of bags. In some examples, the canister 202, or organ container, can be sealed with a lid. In some examples, the canister 202, or organ container, can be sealed with a plug or a closing element other than a lid. In some examples, the canister 202, or organ container, can be closed without a closing element or lid. In some examples, the canister 202, or organ container, can form an insulated environment in an interior of the organ container when closed. For example, forming an insulated environment can mean at least partially insulating or at least partially preventing the loss of heat through the organ container.

In some examples, the perfusion port 252 can be configured to couple with a hypothermic perfusion source. In some examples, the fluid at a hypothermic temperature can have a temperature between 6° C. and 8° C. In some examples, the fluid at a hypothermic temperature can have a temperature between 4° C. and 10° C. In some examples, the fluid at a hypothermic temperature can have a temperature between 2° C. and 10° C. In some examples, the fluid at a hypothermic temperature can have a temperature between 0° C. and 12° C. In some examples, the hypothermic fluid can be preservation solution. In some examples, the hypothermic fluid can be cellular solution.

In some examples, the perfusion port 252 can be fluidically coupled with a vessel of the organ contained in the canister 202 throughout transportation of the organ. In some examples, the perfusion port 252 can be connected to the vessel of the organ through the organ adapter 238. In some examples, the perfusion port 252 can be connected to the vessel of the organ through a cannula and/or a cannula receiver. In some examples, the perfusion port 252 can be fluidically coupled with an aorta, a pulmonary trunk, pulmonary veins, and/or a vena cava of the heart. In some examples, the perfusion port 252 can be fluidically coupled with a renal artery and/or a renal vein of a kidney. In some examples, the perfusion port 252 can be fluidically coupled with a hepatic vein and/or a hepatic artery of a liver. In some examples, the perfusion port 252 can be fluidically coupled with a pulmonary vein and/or a pulmonary artery of a lung. In some examples, the perfusion port 252 can be fluidically coupled with a vein and/or an artery of a pancreas. In some examples, the perfusion port 252 can be fluidically coupled with a vein and/or an artery of an organ. In some examples, the canister 202 can include multiple perfusion ports connected to different vessels of the organ. In some examples, the perfusion port 252 can be in direct fluid communication with the interior of the canister 202 such that fluid from the perfusion source enters the interior of the canister 202 around the organ.

In some examples, the perfusion port 252 can allow the organ to be disconnected from a perfusion source and/or connected to a perfusion source without opening the canister 202. In some examples, an organ can be transported in the canister 202 under conditions of hypothermic static storage. After transporting the organ in the canister 202 with hypothermic static preservation, the perfusion port 252 can be connected with a normothermic perfusion circuit such that the organ can be perfused with fluid at a normothermic temperature. Advantageously, this can allow the organ to be reacclimated to normothermic temperatures before transplantation. In some examples, an organ can be transported in the canister 202 under conditions of hypothermic perfusion. After transporting the organ in the canister 202 with hypothermic perfusion, the perfusion port 252 can be disconnected from the hypothermic perfusion source and connected with a normothermic perfusion circuit such that the organ can be perfused with fluid at a normothermic temperature. Advantageously, the ability to change and/or connect a perfusion source without opening the canister 202 can improve the ability of the transport team to maintain the sterility of the organ storage container.

In some examples, the perfusion port 252 can be connected to a normothermic perfusion circuit before hypothermic static preservation and/or hypothermic perfusion. The normothermic perfusion circuit can be disconnected from the perfusion port 252 before transporting the organ. In some examples, the hypothermic perfusion circuit can then be connected to the perfusion port 252 and remain connected during transportation.

In some examples, a user can remove the canister 202 from a transport container and connect the perfusion port 252 to the normothermic perfusion circuit. In some examples, the user can remove the canister 202 from a transport container, disconnect the perfusion port 252 from a hypothermic perfusion source, and connect the perfusion port 252 to the normothermic perfusion circuit. In some examples, a user can remove the canister 202 from a transport container and connect the perfusion port 252 to a blood perfusion circuit. In some examples, the user can remove the canister 202 from a transport container, disconnect the perfusion port 252 from a preservation solution source, and connect the perfusion port 252 to the blood perfusion circuit. In some examples, a user can remove the canister 202 from a transport container and connect the perfusion port 252 to a preservation solution perfusion circuit. In some examples, the user can remove the canister 202 from a transport container, disconnect the perfusion port 252 from a blood source, and connect the perfusion port 252 to a preservation solution perfusion circuit.

In some examples, the fluid in the canister 202 can be drained through the drain 210 before connecting the perfusion port 252 to a circuit or perfusion source. In some examples, the perfusion port 252 can be closed during transportation to allow for hypothermic or normothermic static preservation. In some examples, the fluid in the canister 202 can be drained through the drain 210 while the perfusion port 252 is coupled with a circuit or perfusion source. In some examples, the drain 210 can be at the bottom of the canister 202. In other examples, the drain 210 can be on the side or on top of the canister 202, for example on the lid. In some examples, the perfusion port 252 can be on the top of the canister 202, for example on the lid. In other examples, the perfusion port 252 can be on a side wall of the canister 202. In other examples, the perfusion port 252 can be on a bottom of the canister 202.

In some examples, the preservation solution and/or the canister 202 can include any or all of the features described in U.S. patent application Ser. No. 17/465,322, filed Sep. 2, 2021, now U.S. Pat. No. 12,279,610, which is incorporated by reference in its entirety herein. In some examples, the canister 202 and/or the perfusion circuit can include any or all of the features described in U.S. patent application Ser. No. 19/041,728, filed Jan. 30, 2025, which is incorporated by reference in its entirety herein.

FIG. 3 shows an example of a normothermic perfusion circuit 300 suspended from a suspension component 344.

In examples, the normothermic perfusion circuit 300 can be similar to the circuit described with respect to FIG. 1. The left atrium reservoir 312 and the aorta reservoir 314 can be suspended to provide a head pressure to the left atrium and the aorta, respectively. The reservoirs 312, 314 can be suspended from a suspension component 344. For example, the suspension component 344 can be a bar, a frame, or a ceiling. The reservoirs 312, 314 can be secured to the suspension component 344 using securement features 346. For example, the securement features 346 can be ropes, ties, strings, clips, adhesives, hooks, and/or clamps.

FIG. 4 shows an example of a graph of left atrial pressure and aortic pressure used to estimate ventricular pressure.

Atrial pressure and aortic pressure can be measured from a donor heart during perfusion. For example, atrial pressure and aortic pressure can be measured from a donor heart during perfusion by the circuit described with respect to FIG. 1. Ventricular pressure can be estimated using the atrial pressure and aortic pressure. Ventricular pressure can be used to indicate heart activity.

In some examples, a straight-line approximation between the aortic pressure measurement and the atrial pressure measurement can be used to estimate ventricular pressure. An example of the straight-line approximation is shown as the dashed line. The approximation can be based on the atrial pressure during certain times of the heart's activity and the aortic pressure during certain times of the heart's activity. In some implementations, a user or processor can create an estimate of a ventricular pressure graph based on the aortic pressure and the atrial pressure. In some implementations, a machine learning (ML) algorithm or artificial intelligence (AI) can determine the estimated ventricular pressure values based on the aortic pressure and the atrial pressure. In some implementations, the resulting estimated graph of ventricular pressure can be used to determine heart activity and/or viability of the donor heart for transplantation. For example, irregular pressures can indicate an issue with the donor heart, which may indicate that the heart is not viable for transplantation. In some examples, irregular pacing of the heartbeat may indicate that the heart is not viable for transplantation. Conversely, healthy estimated ventricular pressure values and/or healthy pacing of the heartbeat based on the estimated ventricular pressure values during perfusion may indicate that the heart is viable for transplantation.

In some implementations, aortic pressure measurements can be considered during isovolumic contraction, ejection, and isovolumic relaxation. In some implementations, aortic pressure measurements can be considered before the aortic valve closes and after the aortic valve opens. In some implementations, atrial pressure measurements can be considered during diastasis and atrial systole. In some implementations, atrial pressure measurements can be considered before the mitral valve closes and after the mitral valve opens. Advantageously, this can allow heart activity to be measured without directly measuring left ventricular pressure. Positioning sensors to measure pressure in the aorta and left atrium instead of the ventricle can allow for less invasive and/or easier sensor placement.

A variety of preservation solutions can be used with the disclosed systems, devices, and methods. In certain examples, this includes approved preservation solutions, such as Histidine Tryptophan Ketoglutarate (HTK) (e.g., HTK Custodial™) and Celsior™ solutions for the preservation of hearts and cardiac tissues, and University of Wisconsin Solution (Viaspan™) and MPS 1 for the preservation of kidney and kidney tissues. Other preservation solutions, including non approved solutions, and off label applications of approved solutions can be used with the devices described herein. Various preservation solutions can be used, including Collins, EuroCollins, phosphate buffered sucrose (PBS), University of Wisconsin (UW) (e.g., Belzer Machine Preservation Solution (MPS)), histidine tryptophan ketoglutarate (HTK), hypertonic citrate, hydroxyethyl starch, and Celsior™. Additional details of these solutions can be found at t′Hart et al. “New Solutions in Organ Preservation,” Transplantation Reviews 2006, vol. 16, pp. 131 141 (2006).

### EXAMPLES

Additional systems and methods are disclosed in the examples below, which should not be viewed as limiting the invention in any way.

Example 1. A method for ex-vivo perfusion of an organ, the method comprising: preserving a donor organ in an organ container containing preservation solution having a temperature of between 2° C. and 10° C., wherein the organ container is coupled with a lid to form an insulated environment in an interior of the organ container; draining, through a drain of the organ container, at least some preservation solution from the interior of the organ container to an exterior of the organ container without removing the lid from the organ container; and perfusing, via a perfusion port of the organ container or the lid, a vessel of the donor organ with fluid having a temperature of between 20° C. and 40° C. without removing the lid from the organ container.

Example 2. The method of example 1, wherein perfusing the vessel of the donor organ comprises pumping, with a pump, the fluid through the perfusion port.

Example 3. The method of any one of examples 1 or 2, wherein the perfusion port is in fluid communication with an adapter, the adapter in fluid communication with the vessel of the donor organ.

Example 4. The method of example 3, wherein the adapter comprises a cannula coupled with the organ container.

Example 5. The method of any one of examples 1-4, wherein draining the at least some preservation solution from the interior of the organ container comprises releasing the fluid from the drain on a bottom surface of the organ container.

Example 6. The method of any one of examples 1-5, wherein the fluid comprises blood.

Example 7. The method of any one of examples 1-6, further comprising disconnecting the perfusion port from a hypothermic perfusion circuit before perfusing the vessel of the donor organ with the fluid.

Example 8. The method of any one of examples 1-7, wherein the donor organ is a heart and the vessel of the donor organ is an aorta.

Example 9. A system for ex-vivo perfusion of an organ comprising: an organ container configured to contain a donor organ, the organ container comprising: an adapter configured to fluidically couple with a vessel of the donor organ; a perfusion port configured to be in fluid communication with the adapter; and a drain configured to allow fluid in the organ container to flow out of the organ container; and a reservoir configured to contain fluid at a normothermic temperature; and a tube configured to fluidically couple the reservoir with the perfusion port such that the reservoir is in fluid communication with the vessel of the organ without opening the organ container.

Example 10. The system of example 9, wherein the adapter is a cannula coupled with a cannula receiver of the organ container.

Example 11. The system of any one of examples 9 or 10, wherein at least one of the perfusion port or the adapter is on a lid of the organ container.

Example 12. The system of any one of examples 9-11, wherein the drain is on a bottom surface of the organ container.

Example 13. The system of any one of examples 9-12, wherein at least one of the perfusion port or the adapter is disposed above the drain.

Example 14. The system of any one of examples 9-13, wherein the fluid contained in the reservoir is blood.

Example 15. The system of any one of examples 9-14, wherein the perfusion port is configured to be closed during transportation.

Example 16. The system of any one of examples 9-15, wherein the perfusion port is configured to be coupled with a hypothermic perfusion circuit during transportation.

Example 17. The system of any one of examples 9-16, further comprising an organ rest configured to support the organ, the organ rest comprising an opening configured to allow fluid to flow between the perfusion port and the drain.

Example 18. The system of any one of examples 9-17, wherein the organ container contains preservation solution at a temperature between 2° C. and 10° C.

Example 19. The system of any one of examples 9-18, wherein the reservoir contains fluid at a temperature between 20° C. and 40° C.

Example 20. The system of any one of examples 9-19, wherein the organ is a heart and the adapter is configured to couple with an aorta.

Example 21. A method for ex-vivo perfusion of an organ, the method comprising: opening a drain of a canister containing a donor organ such that preservation solution flows out of the canister; connecting a tube to a perfusion port of the canister, the tube in fluid communication with a reservoir containing fluid at a normothermic temperature, such that the fluid in the reservoir flows through the perfusion port to an adapter, the adapter in fluid communication with a vessel of the donor organ; and perfusing the donor organ with the fluid at a normothermic temperature without removing a lid from the canister.

Example 22. The method of example 21, further comprising pumping, with a pump, the fluid from the reservoir to the perfusion port.

Example 23. The method of any one of examples 21 or 22, further comprising disconnecting a hypothermic perfusion circuit from the perfusion port of the canister.

Example 24. The method of any one of examples 21-23, wherein the preservation solution is at a temperature of between 2° C. and 8° C.

Example 25. The method of any one of examples 21-24, wherein the reservoir contains fluid at a temperature between 20° C. and 40° C.

Example 26. A system for ex-vivo perfusion of a donor heart comprising: a canister configured to contain a donor heart, the canister comprising: a drain configured to drain preservation fluid from the canister; and a perfusion port configured to connect with an aorta of the donor heart; and a reservoir containing fluid at a normothermic temperature, wherein the donor heart is configured to be perfused with the fluid without opening the canister.

Example 27. A system for ex-vivo perfusion of a heart comprising: a canister configured to contain a donor heart; a first reservoir; a first tube having a proximal end and a distal end, the proximal end in fluid communication with the first reservoir and the distal end configured to fluidically communicate with an aorta of the donor heart; a second reservoir; a second tube having a proximal end and a distal end, the proximal end in fluid communication with the second reservoir and the distal end configured to fluidically communicate with a left atrium of the donor heart; a third reservoir in fluid communication with the first reservoir and the second reservoir by a plurality of tubes; and a pump configured to pump fluid from the third reservoir to at least one of the first reservoir or the second reservoir. 28.

Example 28. The system of example 27, wherein the canister comprises a drain configured to drain fluid from the canister to the third reservoir.

Example 29. The system of any one of examples 27 or 28, further comprising valves configured to selectively allow fluid to flow from the third reservoir to the first reservoir or the second reservoir.

Example 30. The system of any one of examples 27-29, further comprising an oxygenator configured to oxygenate fluid pumped from the third reservoir.

Example 31. The system of any one of examples 27-30, wherein the first reservoir and the second reservoir are configured to release excess fluid to the third reservoir through the plurality of tubes.

Example 32. The system of any one of examples 27-31, wherein the second reservoir is configured to receive fluid from the left atrium of the donor heart via the second tube.

Example 33. The system of any one of examples 27-32, wherein the first reservoir and the second reservoir are positioned above the canister.

Example 34. The system of any one of examples 27-33, wherein the canister comprises one or more ports configured to allow a user to take a sample of the fluid.

Example 35. The system of any one of examples 27-34, wherein the fluid is blood.

Example 36. The system of any one of examples 27-35, wherein the distal end of the first tube is connected to the aorta.

Example 37. The system of any one of examples 27-36, wherein the distal end of the second tube is connected to a pulmonary vein.

Example 38. A method for ex-vivo perfusion of a heart, the method comprising: providing a first reservoir, a second reservoir, and a third reservoir, the third reservoir in fluid communication with the first reservoir and the second reservoir via a plurality of tubes; pumping fluid from the third reservoir to the first reservoir, the first reservoir in fluid communication with an aorta of a donor heart via a first tube; measuring, with one or more sensors, one or more parameters of the donor heart; determining, based on the one or more parameters of the donor heart, whether the heart is active or inactive; and when the heart is active, pumping fluid from the third reservoir to a second reservoir via the plurality of tubes, the second reservoir in fluid communication with a left atrium of the donor heart via a second tube and ceasing pumping fluid from the third reservoir to the first reservoir via the plurality of tubes.

Example 39. The method of example 38, wherein the one or more sensors comprises an electrocardiogram and the one or more parameters of the donor heart comprises electrical activity.

Example 40. The method of any one of examples 38 or 39, wherein the one or more sensors comprises a pressure sensor and the one or more parameters of the donor heart comprises at least one of left atrial pressure, aortic pressure, or left ventricular pressure.

Example 41. The method of any one of examples 38-40, wherein the one or more sensors comprises a pressure sensor and the one or more parameters of the donor heart comprises at least one of left atrial pressure, aortic pressure, and/or left ventricular pressure.

Example 42. The method of any one of examples 38-41, wherein the one or more sensors comprises a temperature sensor and the one or more parameters of the donor heart comprises temperature.

Example 43. The method of any one of examples 38-42, wherein the one or more sensors comprises a flow sensor and the one or more parameters of the donor heart comprises flow velocity of the fluid.

Example 44. The method of any one of examples 38-43, further comprising displaying a weight of at least one of the first reservoir or the second reservoir on a display.

Example 45. The method of any one of examples 38-44, further comprising connecting a distal end of the first tube to the aorta.

Example 46. The method of any one of examples 38-45, further comprising connecting a distal end of the second tube to a pulmonary vein.

Example 47. A method for ex-vivo perfusion of a heart, the method comprising: storing a donor heart in a canister filled with cold preservation solution; draining the cold preservation solution from the canister; and perfusing the donor heart with warm fluid through a port in the canister.

Example 48. The method of example 47, wherein the warm fluid is blood.

Example 49. A system for ex-vivo perfusion of a heart comprising: a canister configured to contain a donor heart, the canister configured to be filled with preservation fluid; a drain disposed at a bottom of the canister, the drain configured to drain the preservation fluid from the canister; and an organ rest positioned above the bottom of the canister, the organ rest configured to support the donor heart as the preservation fluid is drained from the canister.

Example 50. The system of example 49, wherein the organ rest comprises apertures configured to allow preservation fluid above the organ rest to flow to the drain.

Example 51. A method for assessing viability of a donor heart, the method comprising: pumping fluid to a left atrium of a donor heart; measuring, with one or more sensors, one or more parameters of the donor heart; determining, based on the one or more parameters of the donor heart, a left ventricular pressure and a left ventricular volume of the donor heart; determining, based on the left ventricular pressure and the left ventricular volume of the donor heart, an indicator comprising at least one of: an unstressed left ventricular volume of the donor heart; a ventricular contractility of the donor heart; an end-systolic PV relationship of the donor heart; or an end-diastolic PV relationship of the donor heart; and determining, based on the indicator, whether the donor heart is viable for transplantation.

Example 52. A method for assessing viability of a donor heart, the method comprising: pumping fluid to a left atrium of a donor heart; measuring, with a first pressure sensor, a left atrial pressure of the donor heart; measuring, with a second pressure sensor, an aortic pressure of the donor heart; determining, based on the left atrial pressure and the aortic pressure, a ventricular pressure of the donor heart; and determining, based on the ventricular pressure, whether the donor heart is viable for transplantation.

Example 53. A system for ex-vivo perfusion of a heart comprising: a canister configured to contain a donor heart, the canister comprising a port, wherein the port is configured to fluidically communicate with the donor heart when the donor heart is contained in the canister; a reservoir containing fluid at a normothermic temperature; a tube configured to couple the reservoir to the port; and a pump configured to perfuse the donor heart with the fluid from the reservoir when the donor heart is contained in the canister and the tube couples the reservoir to the port.

Example 54. A method for ex-vivo perfusion of an organ, the method comprising: preserving a donor organ in a canister containing a first fluid, wherein the canister is coupled with a lid; perfusing, via a perfusion port of the canister or the lid, a vessel of the donor organ with a second fluid without removing the lid from the canister; and draining, through a drain of the canister, at least some of the first fluid or the second fluid from an interior of the canister to an exterior of the canister without removing the lid from the canister.

Example 55. The method of example 54, wherein the first fluid comprises preservation solution at a temperature between 2° C. and 10° C.

Example 56. The method of any one of examples 54 or 55, wherein the second fluid comprises preservation solution at a temperature between 20° C. and 40° C.

Example 57. The method of any one of examples 54-56, wherein the second fluid comprises blood at a temperature between 20° C. and 40° C.

Example 58. The method of any one of examples 54-57, wherein the first fluid comprises blood preservation solution at a temperature between 20° C. and 40° C.

Example 59. The method of any one of examples 54-58, wherein perfusing the vessel of the donor organ comprises pumping, with a pump, the second fluid through the perfusion port.

Example 60. The method of any one of examples 54-59, wherein the perfusion port is in fluid communication with an adapter, the adapter in fluid communication with the vessel of the donor organ.

Example 61. The method of example 60, wherein the adapter comprises a cannula coupled with the canister.

Example 62. The method of any one of examples 54-61, wherein draining the at least some first fluid from the interior of the canister comprises releasing the first fluid from the drain on a bottom surface of the canister.

Example 63. The method of any one of examples 54-62, further comprising disconnecting the perfusion port from a hypothermic perfusion circuit before perfusing the vessel of the donor organ with the second fluid.

Example 64. The method of any one of examples 54-63, wherein the donor organ is a heart and the vessel of the donor organ is an aorta.

Example 65. A method for ex-vivo perfusion of an organ, the method comprising: preserving a donor organ in an organ container containing preservation solution having a temperature of between 2° C. and 10° C., wherein the organ container is configured to be closed; draining, through a drain of the organ container, at least some preservation solution from an interior of the organ container to an exterior of the organ container while the organ container is closed; and perfusing, via a perfusion port of the organ container or the lid, a vessel of the donor organ with fluid having a temperature of between 20° C. and 40° C. while the organ container is closed.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the principles and features disclosed herein. Various combinations and subcombinations of the various features described herein are possible. Certain examples are encompassed in the claim set listed below.

Although this disclosure describes certain examples, it will be understood by those skilled in the art that many aspects of the methods and devices shown and described in the present disclosure may be differently combined and/or modified to form still further examples or acceptable examples. All such modifications and variations are intended to be included herein within the scope of this disclosure. Indeed, a wide variety of designs and approaches are possible and are within the scope of this disclosure. No feature, structure, or step disclosed herein is essential or indispensable. Moreover, while illustrative examples have been described herein, the scope of any and all examples having equivalent elements, modifications, omissions, combinations (e.g., of aspects across various examples), substitutions, adaptations and/or alterations as would be appreciated by those in the art based on the present disclosure. While certain examples have been described, these examples have been presented by way of example only, and are not intended to limit the scope of protection.

Features, materials, characteristics, or groups described in conjunction with a particular aspect, example, or example are to be understood to be applicable to any other aspect, example or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing examples. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some examples, the actual steps taken in the processes illustrated and/or disclosed may differ from those shown in the figures. Depending on the example, certain of the steps described above may be removed, others may be added. Furthermore, the features and attributes of the specific examples disclosed above may be combined in different ways to form additional examples, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular example. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without user input or prompting, whether these features, elements, and/or steps are included or are to be performed in any particular example.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount.

The scope of the present disclosure is not intended to be limited by the specific disclosures of preferred examples in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method for ex-vivo perfusion of an organ, the method comprising:
preserving a donor organ in an organ container containing preservation solution having a temperature of between 2° C. and 10° C., wherein the organ container is coupled with a lid to form an insulated environment in an interior of the organ container;
draining, through a drain of the organ container, at least some preservation solution from the interior of the organ container to an exterior of the organ container without removing the lid from the organ container; and
perfusing, via a perfusion port of the organ container or the lid, a vessel of the donor organ with fluid having a temperature of between 20° C. and 40° C. without removing the lid from the organ container.

2. The method of claim 1, wherein perfusing the vessel of the donor organ comprises pumping, with a pump, the fluid through the perfusion port.

3. The method of claim 1, wherein the perfusion port is in fluid communication with an adapter, the adapter in fluid communication with the vessel of the donor organ.

4. The method of claim 3, wherein the adapter comprises a cannula coupled with the organ container.

5. The method of claim 1, wherein draining the at least some preservation solution from the interior of the organ container comprises releasing the fluid from the drain on a bottom surface of the organ container.

6. The method of claim 1, wherein the fluid comprises blood.

7. The method of claim 1, further comprising disconnecting the perfusion port from a hypothermic perfusion circuit before perfusing the vessel of the donor organ with the fluid.

8. The method of claim 1, wherein the donor organ is a heart and the vessel of the donor organ is an aorta.

9. A system for ex-vivo perfusion of an organ comprising:
an organ container configured to contain a donor organ, the organ container comprising:
an adapter configured to fluidically couple with a vessel of the donor organ;
a perfusion port configured to be in fluid communication with the adapter; and
a drain configured to allow fluid in the organ container to flow out of the organ container; and
a reservoir configured to contain fluid at a normothermic temperature; and
a tube configured to fluidically couple the reservoir with the perfusion port such that the reservoir is in fluid communication with the vessel of the organ without opening the organ container.

10. The system of claim 9, wherein the adapter is a cannula coupled with a cannula receiver of the organ container.

11. The system of claim 9, wherein at least one of the perfusion port or the adapter is on a lid of the organ container.

12. The system of claim 9, wherein the drain is on a bottom surface of the organ container.

13. The system of claim 9, wherein at least one of the perfusion port or the adapter is disposed above the drain.

14. The system of claim 9, wherein the fluid contained in the reservoir is blood.

15. The system of claim 9, wherein the perfusion port is configured to be closed during transportation.

16. The system of claim 9, wherein the perfusion port is configured to be coupled with a hypothermic perfusion circuit during transportation.

17. The system of claim 9, further comprising an organ rest configured to support the organ, the organ rest comprising an opening configured to allow fluid to flow between the perfusion port and the drain.

18. The system of claim 9, wherein the organ container contains preservation solution at a temperature between 2° C. and 10° C.

19. The system of claim 9, wherein the reservoir contains fluid at a temperature between 20° C. and 40° C.

20. The system of claim 9, wherein the organ is a heart and the adapter is configured to couple with an aorta.
